(19) United States
(12) Patent Application Publication
(10) Pub. No.: US 2011/0298601 A1
(43) Pub. Date: Dec. 8, 2011

(54) Bicycle alarm

(76) Inventor: Kevin Foor, San Rafael, CA (US)

(21) Appl. No.: 12/802,384

(22) Filed: Jun. 7, 2010

(51) Int. Cl. B60R 25/10

(52) U.S. Cl. 340/427

(57) ABSTRACT

The invention herein described is a device and system for a mobile security alarm system for mobile valuable property, and especially for bicycles. The system contains visual and audio alarms, a motion sensitive trip mechanism, and a remote transmitter for remote activation and deactivation. A special feature is a secure locking and unlocking bracket system that allows the alarm component to be moved from one bicycle or possession to another.

### BACKGROUND OF THE INVENTION

This invention relates generally to the field of bicycle security alarms. More specifically, this invention relates to remotely controllable and portable alarm systems for bicycles.

### BACKGROUND OF THE INVENTION

### Description of the Related Art

A number of bicycle alarms have been described in the prior art.

Prior art patent U.S. Pat. No. 6,690,267 B2 issued on Feb. 10, 2004 to inventors Linden et al. This device comprises a remotely controllable bicycle lock and alarm system and a remote control device enabled to facilitate communication between a remote control device and the lock and alarm system. Also provided in the lock and alarm system is an audible alarm for notification of the bicycle operator.

Prior art patent U.S. Pat. No. 5,262,757 issued on Nov. 16, 1993 to inventor Hansen. This device comprises an electronic audible warning device which includes a power source, a motion detector, a tone generator, and a remote push button activation switch.

Prior art patent U.S. Pat. No. 5,023,596 issued on Jun. 11, 1991 to inventors Sirman et al. This device comprises an alarm lock for a bicycle to be secured, comprising a casing having an integral clamping device and containing an alarm siren which can be actuated either by an internal motion sensitive device, or by breaking or disconnecting a security loop which is connected around the article. Both of the alarm devices are connected to an automatically resettable detector circuit which includes a timer for resetting after a predetermined period.

Prior art patent U.S. Pat. No. 4,379,281 issued on Apr. 5, 1983 to inventor Thomas. This device comprises an alarm system for a bicycle in which a collar having an undulating exterior surface is mounted on the handlebar post and rotates therewith. A moveable trigger member is mounted to the bicycle chassis adjacent the collar. Unauthorized rotation of the handlebars causes the collar to rotate against the trigger member, moving that member to close a set of contacts and thereby complete an electrical alarm circuit. The trigger member closes another set of contacts to actuate the alarm if the bicycle is tampered with by removing the collar.

A problem common to all previous devices and methods is that they are dedicated to use on a single bicycle. The devices have to be essentially permanently installed. If it is too easy to remove them, they would become ineffective at providing security for the bicycle. No truly portable alarm system, movable at will from bicycle to bicycle, has been described.

Other problems in the prior art inventions include: difficulty of use, lack of remote control, and lack of features.

There is thus a need in the industry for a modern alarm system for a bicycle that is portable and remotely controlled.

### SUMMARY OF THE INVENTION

The invention herein described is a device and method for the security and protection of a bicycle or other portable valuable device. The device includes a remotely controlled audio alarm that, when activated, will sound when the device is shaken or moved. Brilliant lights flash in connection with the alarm.

An important feature of the current invention is its portability. The device is mounted on a security latch mechanism that comprises two separate brackets joined together. They can only be separated by a special tool, when the alarm is deactivated. One bracket stays permanently affixed to the bicycle, while the other bracket moves with the alarm system. Thus one alarm can move between bicycles, as long as each bicycle is equipped with a receiving bracket.

The primary object of the invention is to provide security for a bicycle or other mobile valuable chattel via an audio and visual alarm system.

Another object of the invention is to provide a remotely controlled audio and visual alarm system.

Another object of the invention is to deter theft of the bicycle or other mobile unit.

Another object of the invention is to provide a method of protecting a fleet of bicycles with just one or a few alarm systems.

Another object of the invention is to provide a portable audio and visual alarm system.

Other objects and advantages of the present invention will become apparent from the following descriptions, taken in connection with the accompanying drawings, wherein, by way of illustration and example, an embodiment of the present invention is disclosed.

### BRIEF DESCRIPTION OF THE DRAWINGS

The drawings constitute a part of this specification and include exemplary embodiments to the invention, which may be embodied in various forms. It is to be understood that in some instances various aspects of the invention may be shown exaggerated or enlarged to facilitate an understanding of the invention.

FIG. 1 is a perspective view of a preferred embodiment of the present invention showing the control panel.

FIG. 2 is an exploded view of the present invention, showing the various parts, both visible from the surface and those hidden inside.

FIG. 3 is a cutaway end view of the present invention mounted on a T-bracket.

FIG. 4 is a view of the interior of the present invention, mounted on a bracket, and the receiving bracket into which the T-bracket is inserted to mount the invention.

FIG. 5 portrays the present invention in locked configuration, aboard a bicycle, and the use of the fork-like bracket removal tool to unlock the bracket.

FIG. 6 is an expanded cutaway side view of the receiving bracket of the present invention, highlighting the spring tabs.

FIG. 7 is a perspective view of the remote control transmitter unit of the present invention

FIG. 8 is the schematic circuit diagram for the electronics of the alarm section of the present invention.

FIG. 9 is the schematic circuit diagram for the electronics of the remote control transmitter unit of the present invention.

### DETAILED DESCRIPTION OF THE PREFERRED EMBODIMENTS

Detailed descriptions of the preferred embodiment are provided herein. It is to be understood, however, that the present invention may be embodied in various forms. Therefore, specific details disclosed herein are not to be interpreted as limiting, but rather as a basis for the claims and as representative basis for teaching one skilled in the art to employ the present invention in virtually any appropriately detailed system, structure or manner.

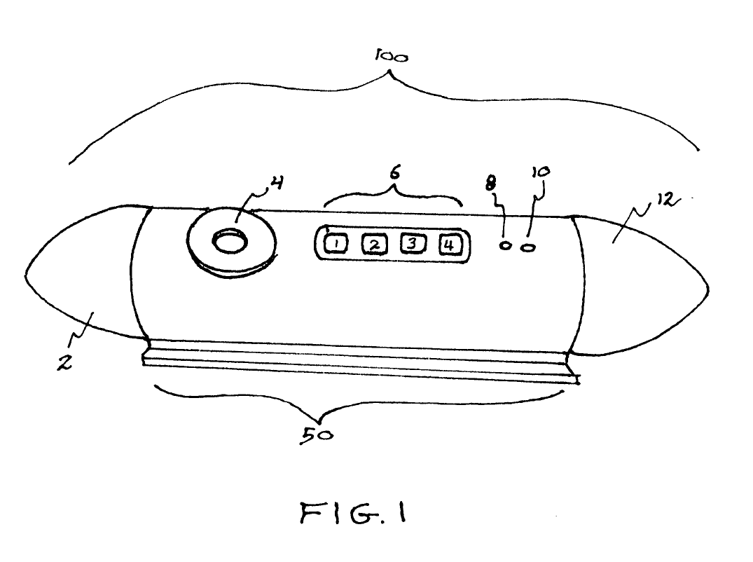

FIG. 1 depicts the components of the invention in straightforward perspective view. The basic structure of the invention is that of a cylinder, which comprises the case 100 for the major components of the alarm system. In the preferred embodiment pictured, the ends of cylinder are capped by conical light covers 2 (white light) and 12 (red light). These will flash when the alarm is triggered, forming the visual portion of the alarm.

Also present on the portrayed face of the housing is speaker 4, control button pad 6, and LED's 8 & 10. Speaker 4 emits the sound for the audio alarm in the current invention. Control button pad 6 enables the user to enter the control code to activate and deactivate the security alarms. LED 8 is the low battery indicator light. When LED is lit, it indicates time to change to a new battery. LED 10 is the armed indicator light. When LED 10 is lit, the alarm is active. It must be deactivated by entering the correct control code at control button pad 6. Preferably, LED 8 and LED 10 are different in color, so that the operator can easily distinguish between the two.

The control panel 6 is programmable to set and reset the code used to activate and deactivate the security alarms. Thus, if the bicycle owner wishes to employ greater security, she can change the code frequently to thwart observers stealing the code. Also, the control panel 6 allows direct keyless entry and disarming of the security alarms. Thus, the owner can use the alarm-protected bicycle directly without needing the remote unit.

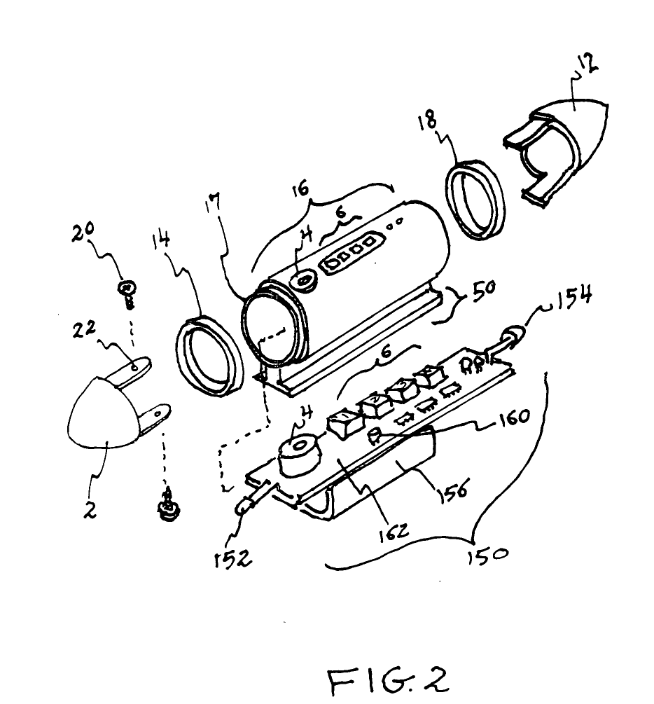

FIG. 2 depicts the components of the preferred embodiment of the current invention in a disassembled, exploded view. The basic structure of the invention is an open cylinder formed by main housing tube 17. This is protected by a Lexan® cover 16. Both housing tube 17 and cover 16 have openings to expose the alarm speaker 4, control pad 6, and LED's 8 & 10.

The open ends of main housing tube 17 are covered by conical light covers 2 & 12. The light covers are attached to the main housing by means of screws 20 applied to light connection tabs 22. At the interface between light covers and main housing are rubber O-rings 18. These O-rings provide watertight integrity to the main housing, keeping the electronic components therein dry, even during inclement weather.

At the bottom of main housing tube 17 is found T-bracket 50. This is the mounting bracket for attachment of the alarm unit to the frame of a bicycle.

Below the T-bracket 50, can be seen, enlarged, the electronic assembly 150, which is normally found inside main housing tube 17. The electronic assembly 150 is comprised of the components that are seen from the surface: alarm speaker 4, control pad 6, and LED's 8 & 10. Also found here are the electronic circuitry aboard a printed circuit board 162, a 9-volt battery 156, and lights 152 (white light) and 154 (red light). The battery supplies the power to operate the audio alarm and flashing lights when the alarm system is activated.

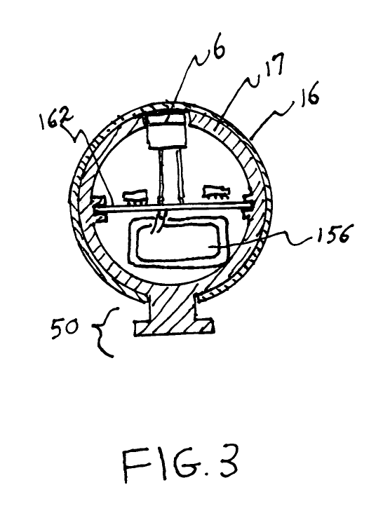

FIG. 3 shows a cutaway of the main housing tube 17 with components of the electronic assembly 150 installed inside. Visible are control pad 6, tube 17 with cover 16, battery 156 below printed circuit board 162, and mounting bracket 50.

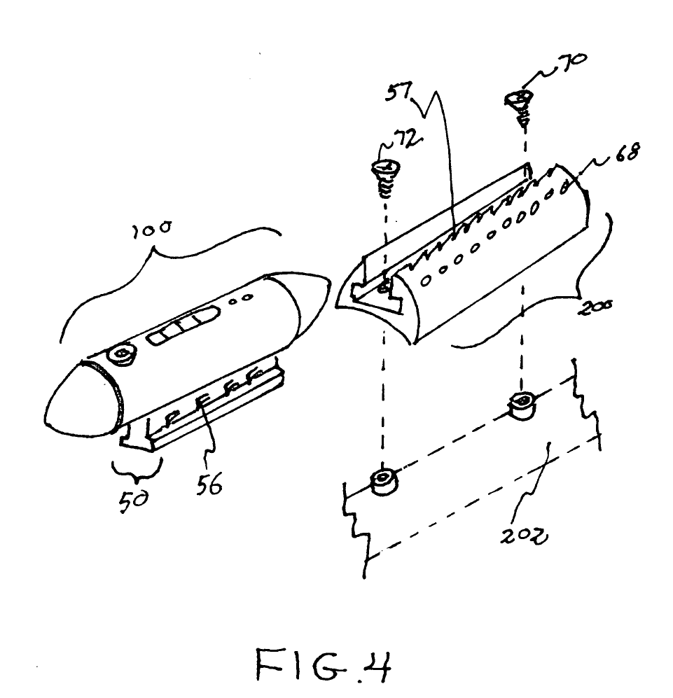

FIG. 4 displays the attachment of alarm system 100 to a bicycle. First, receiving bracket 200 is attached to the bicycle frame 202 by means of screws 70, which are screwed through the bottom of bracket 200 into receiving nuts 204 on frame 202. Then, the alarm system is attached by sliding mounting bracket 50 into the T-shaped channel at the top of receiving bracket 200. Spring tabs 56 at either side of bracket 50 engage ratchet teeth 57 along the channel when inserted. This holds the two brackets 100, 200 firmly together, and thus secures the alarm system to the bicycle.

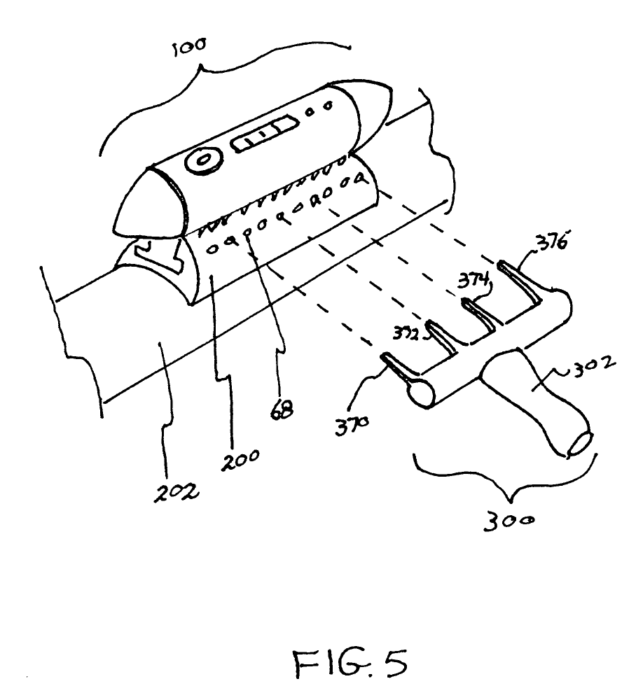

Once the two brackets are thus securely connected, the alarm cannot be removed from the bicycle by normal means. However, there is a mechanism by which the owner can remove the alarm system and reinstall it elsewhere. This is shown in FIG. 5. FIG. 5 shows the alarm system 100 mounted to receiving bracket 200, itself fixedly attached to the frame 202 of a bicycle. Should the owner desire to remove the alarm system 100, the special dismounting tool 300 is called into action. This tool has handle 302 and precisely spaced times 370, 372, 374, & 378. The tines fit precisely into receiving apertures 68 in receiving bracket 200. When the tines of dismounting tool 300 are applied to receiving apertures 68, the spring tabs 56 at either side of bracket 50 disengage from ratchet teeth 57, and alarm system 100 can be removed by sliding bracket 50 out of receiving bracket 200. The alarm system must be deactivated during this process, or the alarms will be tripped.

The unique ability of the current invention can now be appreciated. An owner of several bicycles need not purchase an expensive alarm system for each bicycle. Instead, he can simply attach inexpensive receiving brackets to each bicycle. Then, the alarm system can be reliably and securely detached from one bicycle and attached to another whenever desired. The control code can be reprogrammed as frequently as desired, to add further security.

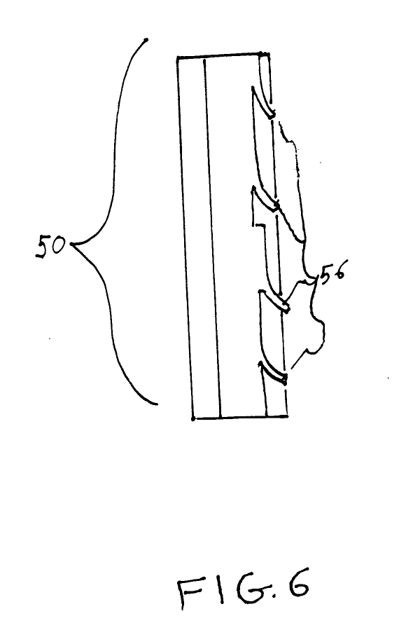

The spring tabs 56 at either side of bracket 50 are shown in close-up view in FIG. 6. It can be seen that the tines of the dismounting tool 300 will force the spring tabs down, into a horizontal position, so that they no longer engage ratchet teeth 57.

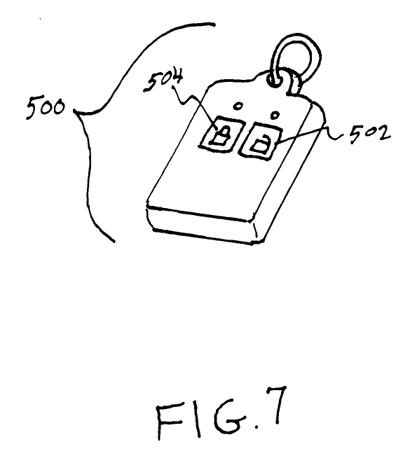

FIG. 7 shows the remote control transmitter unit 500. Unlike the control pad 6, where a coded sequence of numbers is required, the remote control unit only has two buttons. These are button 502, to deactivate the alarm system, and button 504, to activate the alarm system. As the remote unit is normally kept remote from the bicycle, this simple arrangement works well.

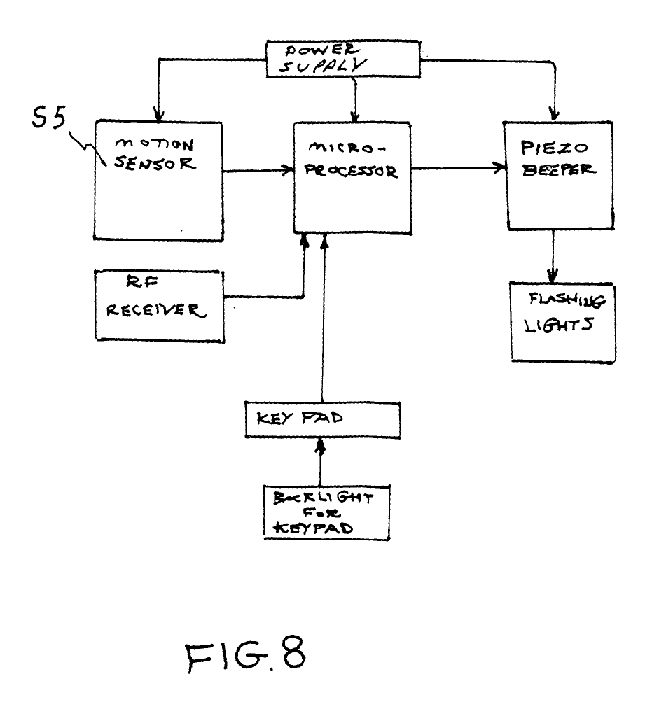

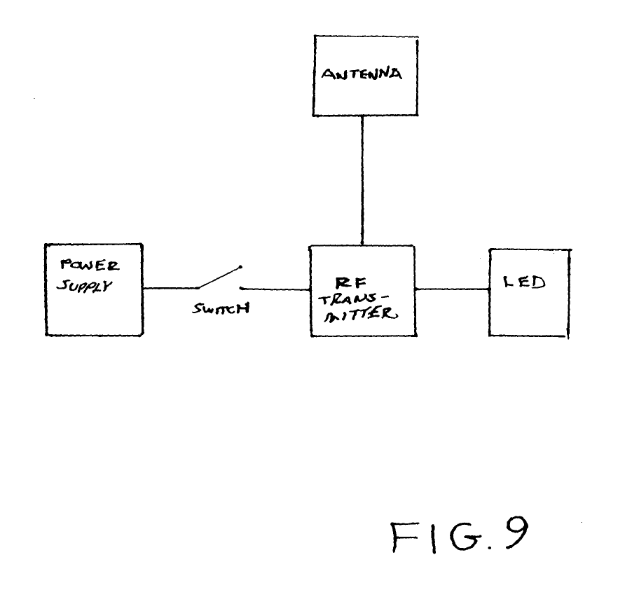

The circuitry for the printed circuit board 162 is depicted in FIG. 8. The board includes motion sensing switch S5 at the upper left of the figure. When the board is shaken when activated, the switch will close, setting off the audio and visual alarms of the system. The much simpler electronic circuit schematic for the transmitter is shown in FIG. 9.

While the invention has been described in connection with a preferred embodiment or embodiments, it is not intended to limit the scope of the invention to the particular form set forth, but on the contrary, it is intended to cover such alternatives, modifications, and equivalents as may be included within the spirit and scope of the invention as defined by the appended claims.

I claim:

1. A portable security alarm system, comprising:
An audio alarm component, composed of sound-emitting horn;
A visual alarm component, composed of a plurality of lights;
A battery to supply electrical power to the alarm components;
A housing, inside which is contained the alarm components, the battery,
and an electronic wiring circuit to route electrical power from the battery to the alarm components;
a motion-sensitive component to initiate the alarms;
A control panel, to activate and deactivate the alarm components;
A mounting bracket, permanently affixed to the surface of said housing; and,
A receiving bracket, permanently affixable to the surface of a bicycle frame.

2. The system of claim 1, wherein said visual alarm component is comprised of lights, said lights capable of flashing when said alarm component is activated.

3. The system of claim 1, wherein said visual alarm component is comprised of strobe lights.

4. The system of claim 1, further comprising a remote control transmitter.

5. The system of claim 1, wherein said mounting bracket is a T-bracket.

6. The system of claim 1, wherein said receiving bracket is a bracket capable of insertion of a T-bracket.

7. The system of claim 1, wherein said means of connecting brackets comprise the interlocking of ratchet teeth with spring barbs, wherein said ratchet teeth and said spring barbs are components of said brackets.

8. The system of claim 7, further comprising a hand tool, in the shape of a fork with a plurality of tines, wherein said tines are conformably disposed to interact with the spring barbs of said connecting brackets to release said barbs from interaction with said ratchet teeth.

9. The system of claim 1, wherein said housing is composed of an inner tube containing components and circuitry, and an outer protective layer.

10. The system of claim 1, further comprising a timer for triggering the alarms.

11. The system of claim 1, wherein said control panel is programmable to accept a coded entry for activation and deactivation of said alarm components.

12. A portable security alarm system for a bicycle, comprising:
An audio alarm component, composed of sound-emitting horn;
A visual alarm component, composed of a plurality of lights, at least one at either end of the device;
A battery to supply electrical power to the alarm components;
A cylindrically shaped housing, inside which is contained the alarm components, the battery,
and an electronic wiring circuit to route electrical power from the battery to the alarm components;
a motion-sensitive component to initiate the alarms;
A control panel, to activate and deactivate the alarm components by means of a programmable code;
A mounting bracket, permanently affixed to the surface of said housing; and,
A receiving bracket, permanently affixable to the surface of a bicycle frame; wherein,
The mounting bracket and receiving bracket are connected by interlocking means which are not reversible without the use of a special dismounting fork tool.
